(19) United States
(12) Patent Application Publication
(10) Pub. No.: US 2014/0293398 A1
(43) Pub. Date: Oct. 2, 2014

(54) ELECTROPHORETIC DISPLAY DEVICE

(71) Applicant: SIPIX IMAGING, INC., Fremont, CA (US)

(72) Inventors: Ming WANG, Fremont, CA (US); Craig LIN, San Jose, CA (US); Hui DU, Milpitas, CA (US); HongMei ZANG, Fremont, CA (US); XiaoJia ZHANG, Fremont, CA (US)

(73) Assignee: SIPIX IMAGING, INC., Fremont, CA (US)

(21) Appl. No.: 13/853,367

(22) Filed: Mar. 29, 2013

(51) Int. Cl. G02F 1/167

(52) U.S. Cl. CPC G02F 1/167
USPC 359/296

(57) ABSTRACT

The present invention is directed to an electrophoretic display device which is suitable for passive matrix driving. The electrophoretic fluid may comprise two types of charged pigment particles wherein the two types of charged pigment particles carry opposite charge polarities, have contrasting colors and have different levels of charge intensity. Alternatively, there may be a third type of particles added to the fluid.

### FIELD OF THE INVENTION

The present invention is directed to electrophoretic display designs and methods for driving such electrophoretic displays.

### BACKGROUND OF THE INVENTION

The electrophoretic display (EPD) is a non-emissive device based on the electrophoresis phenomenon of charged pigment particles dispersed in a solvent. The display typically comprises two plates with electrodes placed opposing each other. One of the electrodes is usually transparent. An electrophoretic fluid composed of a colored solvent with charged pigment particles dispersed therein is enclosed between the two plates. When a voltage difference is imposed between the two electrodes, the pigment particles migrate to one side or the other causing either the color of the pigment particles or the color of the solvent being seen from the viewing side.

Alternatively, an electrophoretic fluid may comprise two types of charged pigment particles of contrasting colors and carrying opposite charges, and the two types of the charged pigment particles are dispersed in a clear solvent or solvent mixture. In this case, when a voltage difference is imposed between the two electrode plates, the two types of the charged pigment particles would move to opposite ends (top or bottom) in a display cell. Thus one of the colors of the two types of the charged pigment particles would be seen at the viewing side of the display cell.

### SUMMARY OF THE INVENTION

The present invention is directed to an electrophoretic display comprising

a) a plurality of pixels each of which
(i) has a viewing side and a non-viewing side, and
(ii) is sandwiched between a top electrode and a bottom electrode; and

b) an electrophoretic fluid comprising two types of charged pigment particles which
(i) carry opposite charge polarities,
(ii) have contrasting colors of a first color and a second color and,
(iii) have different levels of charge intensity,
   wherein when a voltage is applied to a pixel, which is at least one third of the voltage required to drive the pixel from the first color to the second color or from the second color to the first color, the pixel remains unchanged in color on the viewing side whereas a mixture of the two types of charged pigment particles gather at the non-viewing side to form an intermediate color between the first color and the second color.

In one embodiment, the top electrode and the bottom electrode are row and column electrodes in a passive matrix driving system.

In one embodiment, the two types of charged pigment particles are black and white. In one embodiment, the white particles are negatively charged and the black particles are positively charged, or vice versa.

In one embodiment, the volume of the black particles is about 6% to about 15% of the volume of the oppositely charged white particles. In another embodiment, the volume of the black particles is about 20% to about 50% of the volume of the oppositely charged white particles.

In one embodiment, the electrophoretic fluid further comprises a third type of particles.

In one embodiment, the third type of particles is white or black.

In one embodiment, the third type of particles are non-charged or slightly charged.

In one embodiment, the third type of particles is larger than the oppositely charged black and white particles. In one embodiment, the third type of particles is about 2 to about 50 times the size of the oppositely charged black or white particles. In one embodiment, the size of the third type of particles is larger than 20 μm.

In one embodiment, the third type of particles is formed from a polymeric material.

In one embodiment, the third type of particles has a different level of mobility than those of the oppositely charged black and white particles.

In one embodiment, the concentration of the third type of particles is less than 25% by volume in the fluid.

### BRIEF DISCUSSION OF THE DRAWINGS

FIG. 1 depicts an electrophoretic display.

FIGS. 2-5 illustrate different designs of electrophoretic display.

FIGS. 6a-6b illustrate a passive matrix driving system.

FIGS. 7a-7d illustrate a passive matrix driving method utilizing the electrophoretic display of FIGS. 2-5.

FIGS. 8a-8e illustrate an alternative driving method.

### DETAILED DESCRIPTION OF THE INVENTION

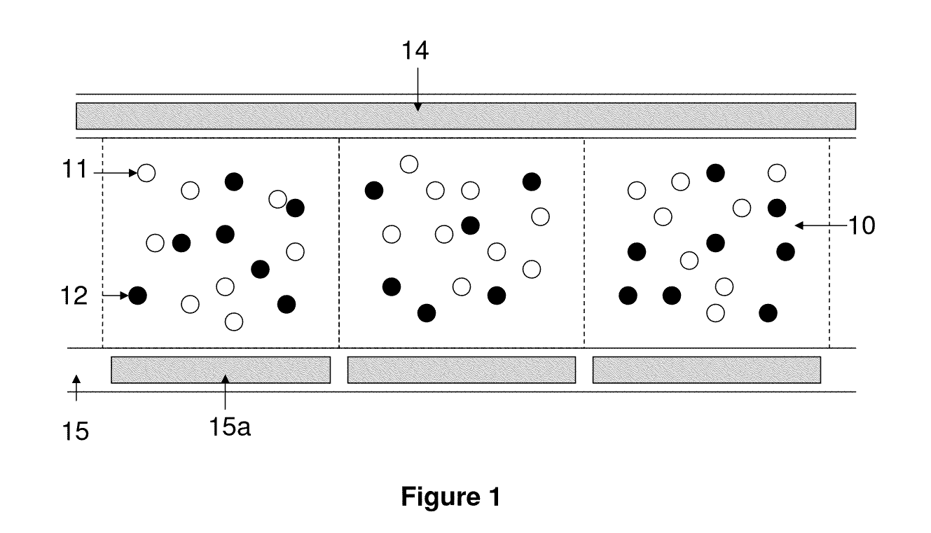

An electrophoretic display is depicted in FIG. 1, wherein an electrophoretic fluid (10) is sandwiched between two electrode layers. One of the electrode layers is a top electrode (14) and the other electrode layer (15) is a layer of bottom electrodes (15a).

For active matrix driving, the top electrode (14) is a common electrode which is a transparent electrode layer (e.g., ITO), spreading over the entire top of the display device and the bottom layer (15) is a thin-film-transistor backplane. In passive matrix driving, the top and bottom electrodes are row and column electrodes. The present invention is particularly suitable for passive matrix driving.

The electrophoretic fluid is partitioned by the dotted lines, as individual pixels. Each pixel has a corresponding bottom electrode.

The fluid (10), as shown, comprises at least two types of pigment particles dispersed in a dielectric solvent or solvent mixture. For ease of illustration, the two types of pigment particles may be referred to as white particles (11) and black particles (12) as shown in FIG. 1. However, it is understood that the scope of the invention broadly encompasses pigment particles of any colors as long as the two types of pigment particles have visually contrasting colors.

For the white particles (11), they may be formed from an inorganic pigment, such as TiO₂, ZrO₂, ZnO, Al₂O₃, Sb₂O₃, BaSO₄, PbSO₄ or the like.

For the black particles (12), they may be formed from CI pigment black 26 or 28 or the like (e.g., manganese ferrite black spinel or copper chromite black spinel) or carbon black.

The solvent in which the three types of pigment particles are dispersed may be clear and colorless. It preferably has a low viscosity and a dielectric constant in the range of about 2 to about 30, preferably about 2 to about 15 for high particle mobility. Examples of suitable dielectric solvent include hydrocarbons such as isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzotrifluoride, chloropentafluoro-benzene, dichlorononane or pentachlorobenzene, and perfluorinated solvents such as FC-43, FC-70 or FC-5060 from 3M Company, St. Paul Minn., low molecular weight halogen containing polymers such as poly(perfluoropropylene oxide) from TCI America, Portland, Oreg., poly(chlorotrifluoro-ethylene) such as Halocarbon Oils from Halocarbon Product Corp., River Edge, N.J., perfluoropolyalkylether such as Galden from Ausimont or Krytox Oils and Greases K-Fluid Series from DuPont, Del. and polydimethylsiloxane based silicone oil from Dow-corning (DC-200).

The two types of pigment particles carry opposite charge polarities. For example, if the black particles are positively charged and the white particles are negatively charged, or vice versa.

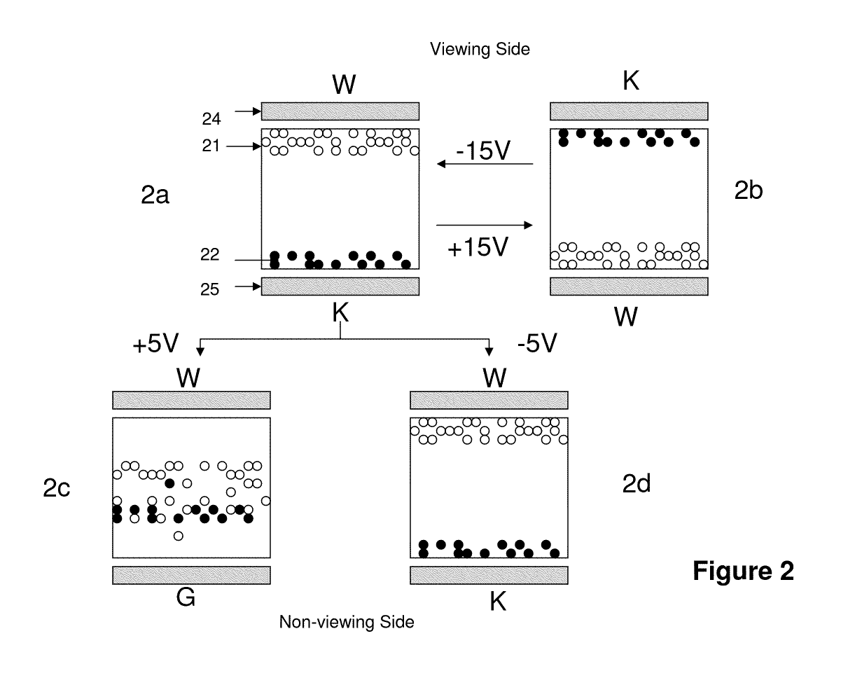

FIG. 2 depicts one of the electrophoretic display designs of the present invention. In this example, the white particles (21) are negatively charged while the black particles (22) are positively charged. In this design, the volume of the black particles is about 6% to about 15% of the volume of the white particles.

The levels of charge intensity of the two types of particles are different. For example, the white particles may have a zeta potential of −100 whereas the black particles have a zeta potential of +30.

In FIG. 2a, when an applied voltage potential is −15V, the white particles (21) move to be near or at the top electrode (24) and the black particles (22) move to be near or at the bottom electrode (25). As a result, the white color is seen at the viewing side.

In FIG. 2b, when a voltage potential difference of +15V is applied, the white particles (21) move to be near or at the bottom electrode (25) and the black particles (22) move to be near or at the top electrode (24). As a result, the black color is seen at the viewing side.

In FIG. 2c, when a voltage potential difference of +5V (which is ⅓ of the voltage potential difference required to drive a pixel from a full white state to a full black state) is applied to the particles in FIG. 2a (that is, driving from a white color state), the negatively charged white particles (21) move towards the bottom electrode (25). The relative charge intensity of the white (21) and the black (22) particles is such that the black particles move little and as a result, the white color is still seen at the viewing side while a mixture of the white and the black particles gather at the non-viewing side to form a grey color (i.e., an intermediate color state between white and black).

Because there is a sufficient amount of white particles to block the view of the black particles, the color seen is a high quality white.

In FIG. 2d, when a voltage potential difference of −5V (which is ⅓ of the voltage potential difference required to drive a pixel from a full black state to a full white state) is applied to the particles in FIG. 2a (that is, driving from a white color state), the black and white particles would barely move because of their respective charge polarities and therefore the color seen remains to be white at the viewing side.

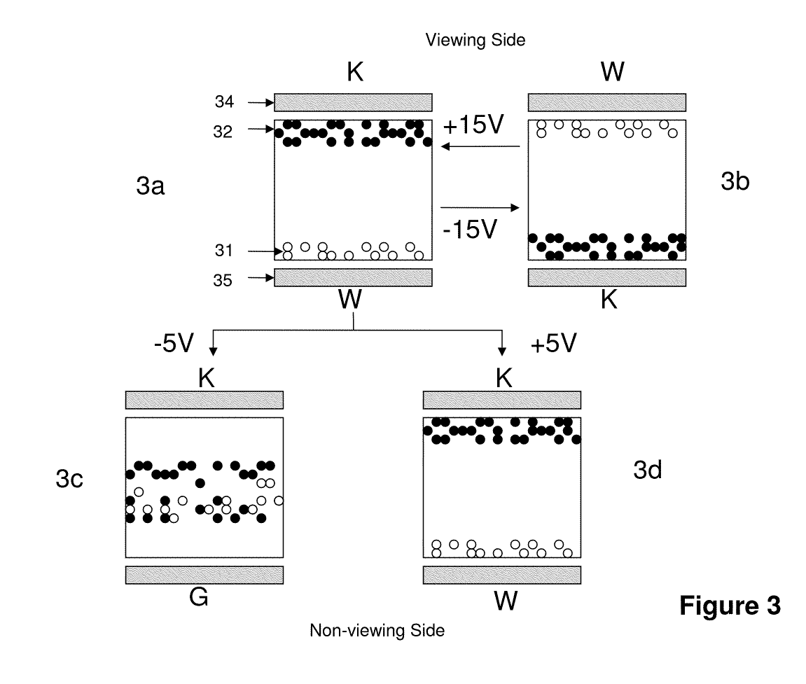

FIG. 3 depicts an alternative electrophoretic display design of the present invention. In this example, the white particles (31) are negatively charged while the black particles (32) are positively charged. In this embodiment, the volume of the black particles is about 20% to about 50% of the volume of the white particles.

In FIG. 3a, when a voltage potential difference of +15V is applied, the white particles (31) move to be near or at the bottom electrode (35) and the black particles (32) move to be near or at the top electrode (34). As a result, the black color is seen at the viewing side.

In FIG. 3b, when an applied voltage potential is −15V, the white particles (31) move to be near or at the top electrode (34) and the black particles (32) move to be near or at the bottom electrode (35). As a result, the white color is seen at the viewing side.

In FIG. 3c, when a voltage potential difference of −5V (which is ⅓ of the voltage potential difference required to drive a pixel from a full black state to a full white state) is applied to the particles in FIG. 3a (that is, driving from a black color state), the positively charged black particles (32) move towards the bottom electrode (35). The relative charge intensity of the black and white particles is such that the white particles (31) move little and as a result, the black color is still seen at the viewing side while a mixture of the white and black particles gather at the non-viewing side to form a grey color (i.e., an intermediate color state between white and black).

In FIG. 3d, when a voltage potential difference of +5V (which is ⅓ of the voltage potential difference required to drive a pixel from a full white state to a full black state) is applied to the particles in FIG. 3a (that is, driving from a black color state), the black and white particles would barely move because of their respective charge polarities and therefore the color seen remains to be black at the viewing side.

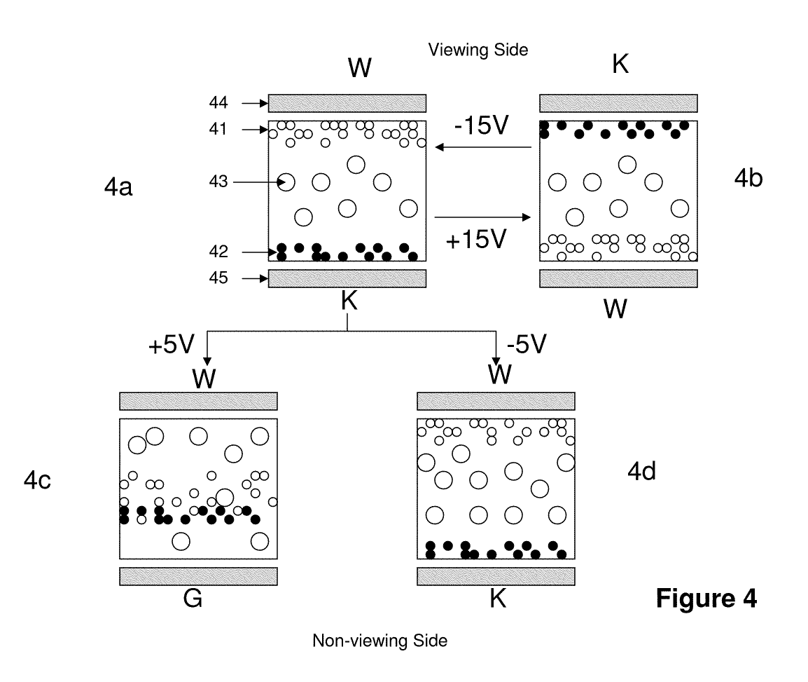

In another alternative design as shown in FIG. 4, a third type (43) of particles is added.

In FIG. 4, the third type (43) of particles which is of the white color is dispersed in the fluid. However, they barely move when a voltage potential is applied to the fluid, because they are non-charged or slightly charged. FIGS. 4(a) to 4(d) are similar to FIGS. 2(a) to 2(d), respectively, except that there is the third type of particles in the fluid in FIG. 4. More details of the third type of particles are given in a section below.

While the third type of particles is present, even though there is not a sufficient amount of the white particles present, the third type of particles would block the view of the black particles from the viewing side to allow a high quality white color to be seen.

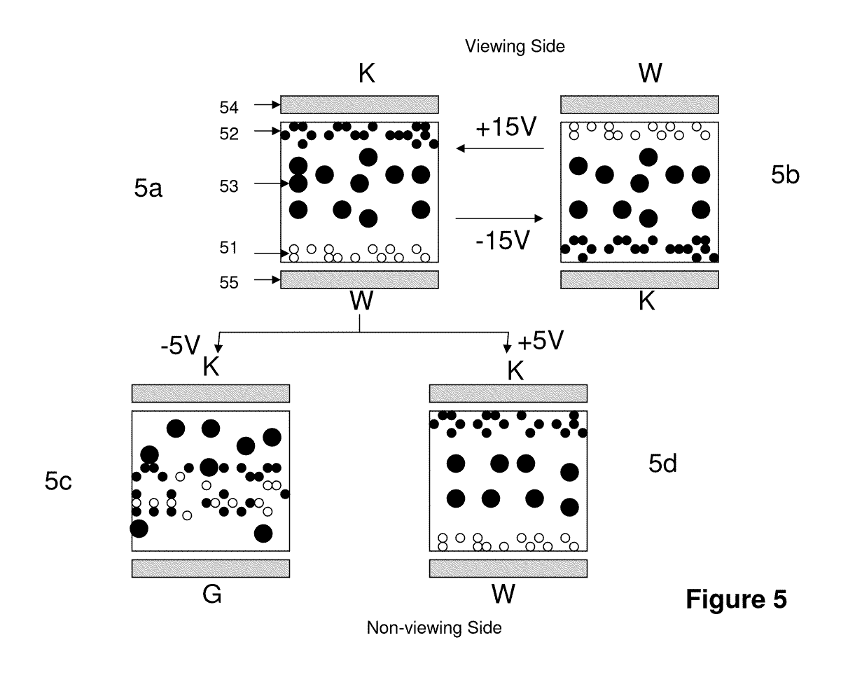

In FIG. 5, the third type (53) of particles which is of the black color is dispersed in the fluid. However, they barely move when a voltage potential is applied to the fluid, because they are non-charged or slightly charged. FIGS. 5(a) to 5(d) are similar to FIGS. 3(a) to 3(d), respectively, except that there is the third type of particles in the fluid in FIG. 5.

It is noted that while one third of the voltage required to drive a pixel from a first color state (e.g., white) to a second color state (e.g., black) or from the second color state to the first color state is applied in FIGS. 2c, 2d, 3c, 3d, 4c, 4d, 5c and 5d, in practice, the voltage applied may be higher than that. In other words, the voltage applied in those figures may be at least one third of the voltage required to drive a pixel from a first color state to a second color state or from the second color state to the first color state

The third type of particles in FIGS. 4 and 5 may be larger than the oppositely charged black and white particles. For example, both the black (42 or 52) and the white (41 or 51) particles may have a size ranging from about 50 nm to about 800 nm and more preferably from about 200 nm to about 700 nm, and the third type (43 or 53) of particles may be about 2 to about 50 times and more preferably about 2 to about 10 times the size of the black particles or the white particles. In one embodiment, the size of the third type of particles is larger than 20 μm.

The third type of particles in FIG. 4 or 5 preferably has a color which is the same as one of the two types of charged particles. For example, if the two types of charged particles are black and white, the third type of particles is either white or black. The third type of particles may be formed from the materials described above for the black and white particles.

The third type of particles may also be formed from a polymeric material. The polymeric material may be a copolymer or a homopolymer. Examples of the polymeric material may include, but are not limited to, polyacrylate, polymethacrylate, polystyrene, polyaniline, polypyrrole, polyphenol, polysiloxane or the like. More specific examples of the polymeric material may include, but are not limited to, poly(pentabromophenyl methacrylate), poly(2-vinylnapthalene), poly(naphthyl methacrylate), poly(alpha-methystyrene), poly(N-benzyl methacrylamide) or poly(benzyl methacrylate).

In addition, the third type of particles is preferably slightly charged. The term “slightly charged” is defined as having a charge intensity which is less than 50%, preferably less than 25% and more preferably less than 10%, of the average charge intensity carried by the positively or negatively charged pigment particles. In one embodiment, the third type of particles is slightly charged and it has a different level of mobility than those of the black and white particles.

The concentration of the third type of particles is less than 25%, preferably less than 10%, by volume in the fluid.

There may be other particulate matters in the fluid which are included as additives to enhance performance of the display device, such as switching speed, imaging bistability and reliability.

The electrophoretic fluid in an electrophoretic display device is filled in display cells. The display cells may be microcups as described in U.S. Pat. No. 6,930,818, the content of which is incorporated herein by reference in its entirety. The display cells may also be other types of micro-containers, such as microcapsules, microchannels or equivalents, regardless of their shapes or sizes. All of these are within the scope of the present application.

The display designs of FIGS. 2-5 may be driven by an active matrix driving system or a passive matrix driving system. However, the designs are particularly suitable for passive matrix driving, examples of which are given below.

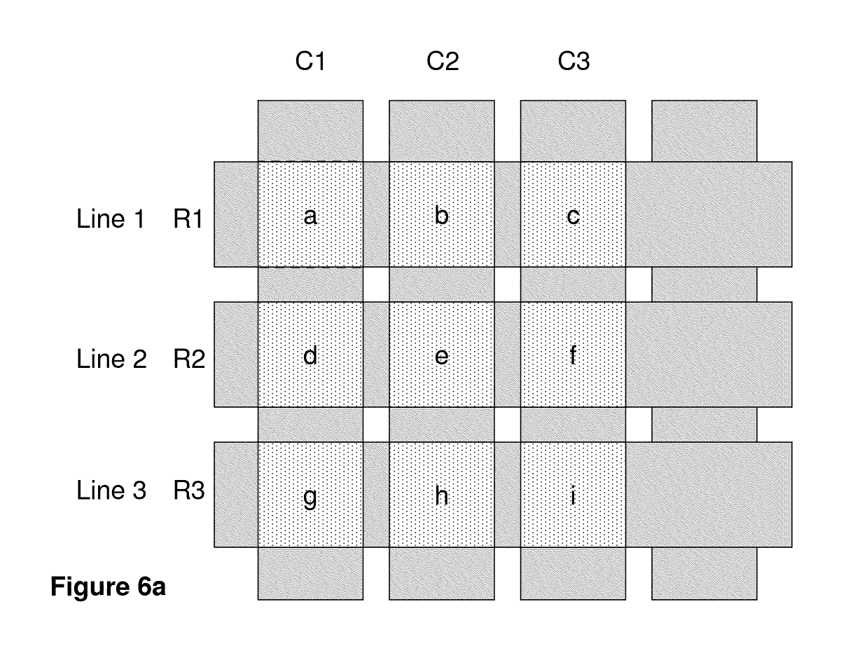

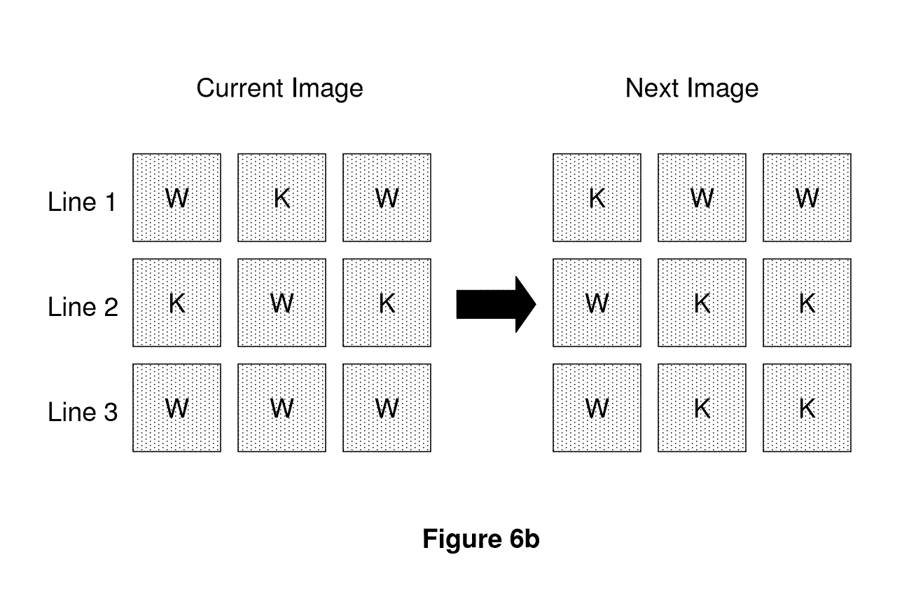

FIG. 6a depicts a typical passive matrix configuration. As shown the column electrodes (C1-C3) are perpendicular to the row electrodes (R1-R3). In this example, the column electrodes are shown to be underneath the row electrodes. The spaces where the row electrodes and the column electrodes overlap are pixels and therefore for each pixel, the row electrode would be the top electrode and the column electrode would be the bottom electrode. The 9 pixels shown are pixels (a)-(e), for illustration purpose. Pixels (a)-(c) are at line 1; pixels (d)-(f) are at line 2; and pixels (g)-(i) are at line 3.

In FIG. 6b, two images are shown. In the current image, pixels (a)-(i) are W (white), K (black), W, K, W, K, W, W and W, respectively. In the next image, pixels (a)-(i) are K, W, W, W, K, K, W, K and K, respectively. The following examples demonstrate methods for driving the current image to the next image.

### EXAMPLE 1

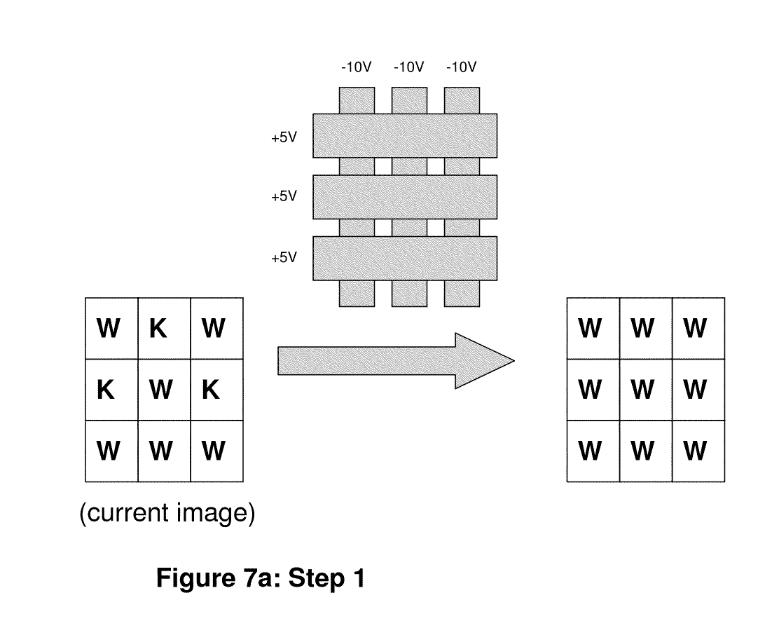

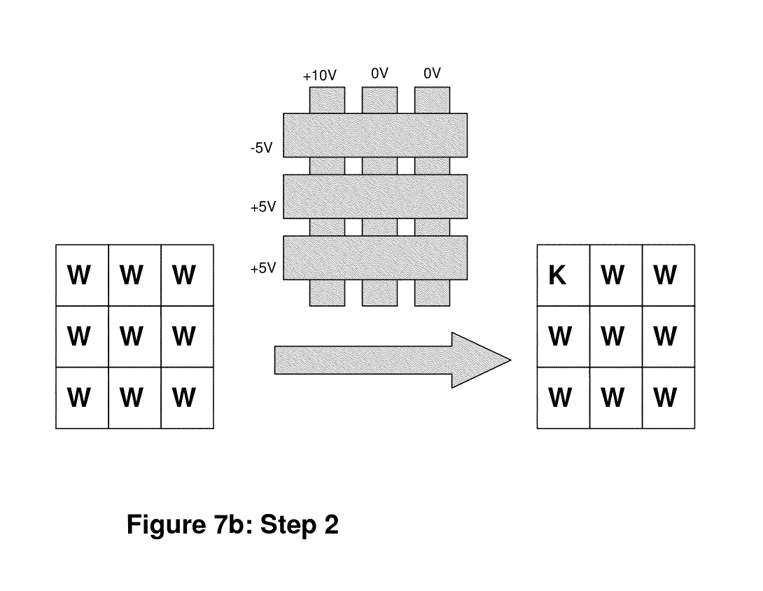

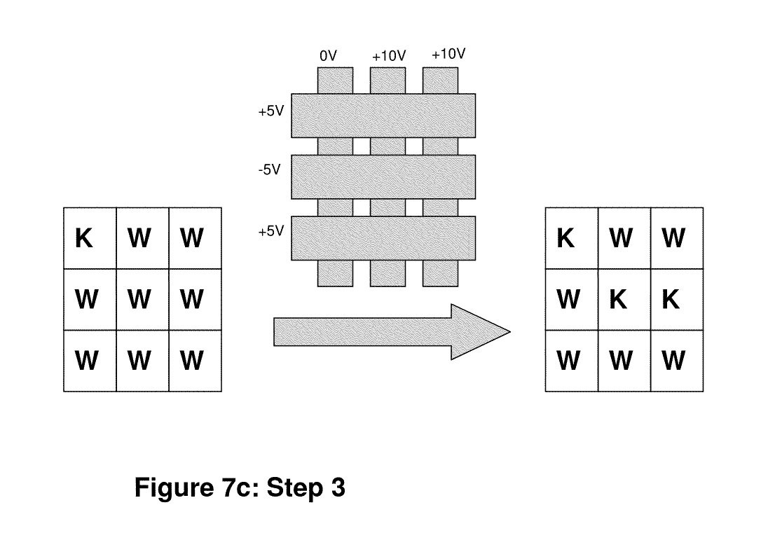

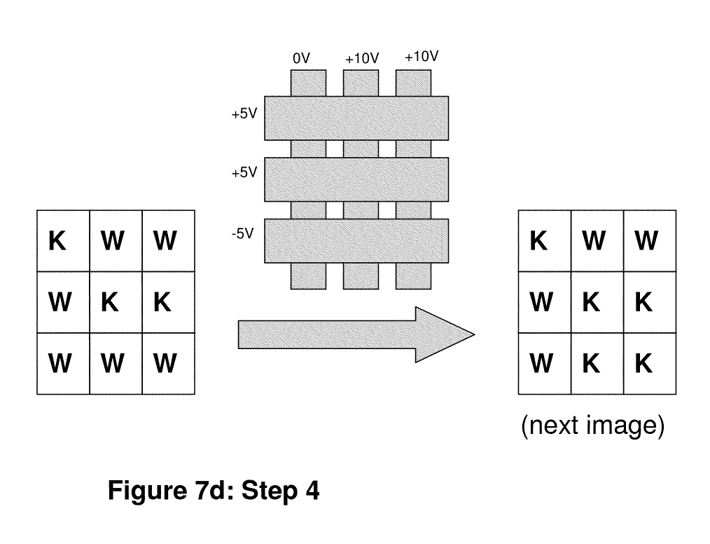

FIGS. 7a-7d shows the steps of one of the passive matrix driving methods. In step 1 (FIG. 7a), all pixels (a)-(i) are driven to the white state regardless of their current color states. To accomplish this, all column electrodes C1-C3 are applied a voltage of −10V and all row electrodes R1-R3 are applied a voltage of +5V. As a result, all of pixels sense a driving voltage of −15V and therefore switch to the white state (see FIGS. 2a, 3b, 4a and 5b).

In the next step, only line 1 is driven to switch any pixels to black if the pixels are to be in the black state in the next image. In this example, pixel (a) is the only pixel that needs to be driven to the black state (see FIG. 7b). To accomplish this, column electrodes C1-C3 are applied voltages of +10V, 0V and 0V, respectively, and row electrodes R1-R3 are applied voltages of −5V, +5V and +5V, respectively. As a result, pixel (a) senses a driving voltage of +15V, and therefore switches to the black state (see FIGS. 2b, 3a, 4b and 5a). The colors of remaining pixels sensing a voltage of +5V or −5V will remain white (see FIGS. 2c, 2d, 4c and 4d).

In the next step, only line 2 is driven to switch any pixels to black if the pixels are to be in the black state in the next image. In this example, pixels (e) and (f) are the only pixels that need to be driven to the black state (FIG. 7c). To accomplish this, column electrodes C1-C3 are applied voltages of 0V, +10V and +10V, respectively and row electrodes R1-R3 are applied voltages of +5V, −5V and +5V, respectively. Both pixels (e) and (f) sense a driving voltage of +15V and therefore switch from white to black and the remaining pixels sensing a voltage of either +5V or −5V remain unchanged in their color states.

In the next step, only line 3 is driven to switch any pixels to black if the pixels are to be in the black state in the next image. In this example, pixels (h) and (i) are the only pixels that need to be driven to the black state (FIG. 7d). To accomplish this, column electrodes C1-C3 are applied voltages of 0V, +10V and +10V, respectively and row electrodes R1-R3 are applied voltages of +5V, +5V and −5V, respectively. Both pixels (h) and (i) sense a driving voltage of +15V and therefore switch from white to black and the remaining pixels sense a voltage of either +5V or −5V and therefore their colors remain unchanged.

The driving, as shown, after the initial step of driving all pixels to the white color state, is carried out line by line until the last line when all of the pixels have been driven to their color states in the next image.

While black and white color states are used to exemplify the method, it is understood that the present method can be applied to any two color states as long as the two color states are visually distinguishable. Therefore the driving method may be summarized as:

A driving method for driving a display device of a binary color system of a first color and a second color, from a current image to a next image, which method comprises

a) driving all pixels to the first color regardless of their colors in the current image; and

(b) driving, line by line, any pixels which are in the second color in the next image, from the first color to the second color.

### EXAMPLE 2

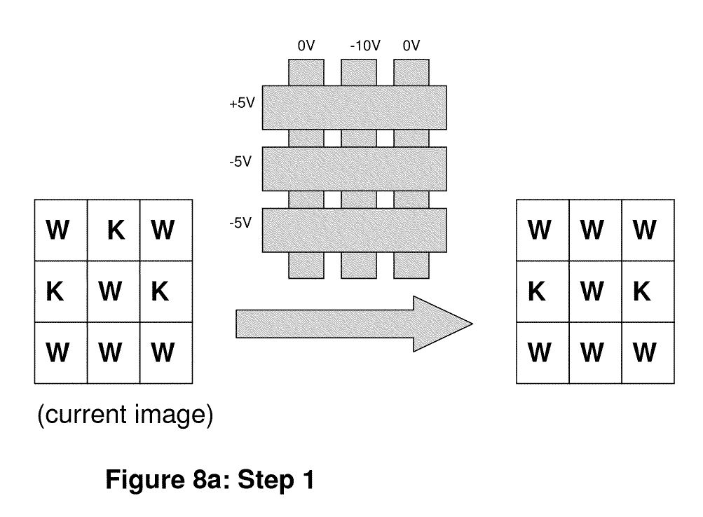

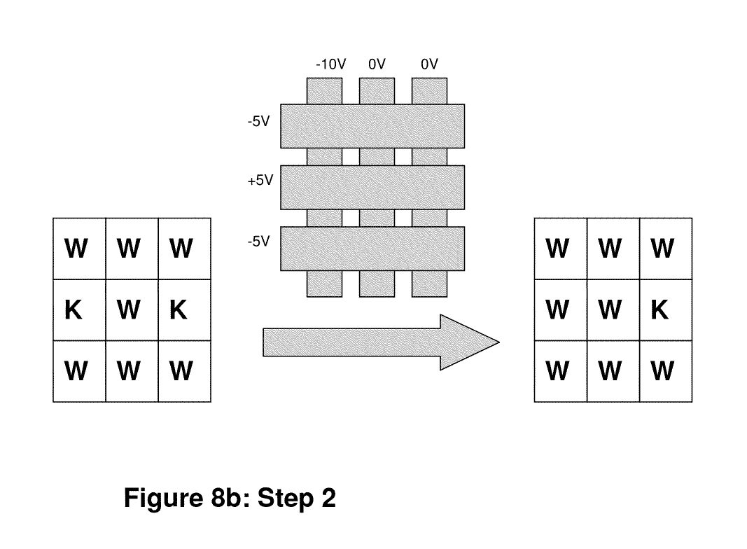

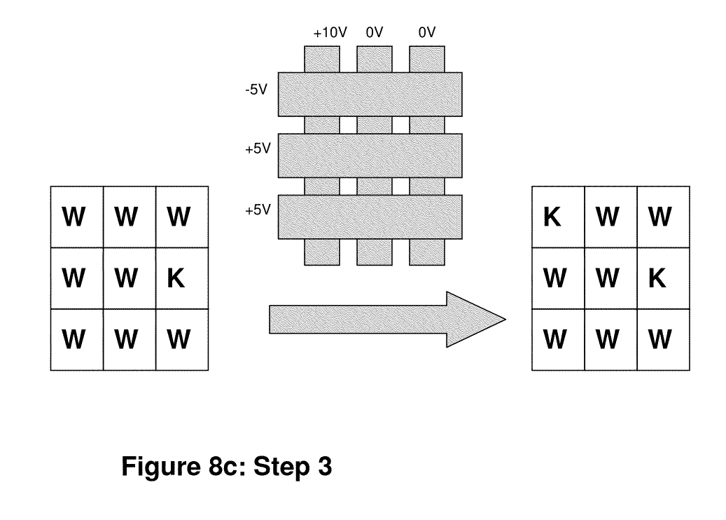

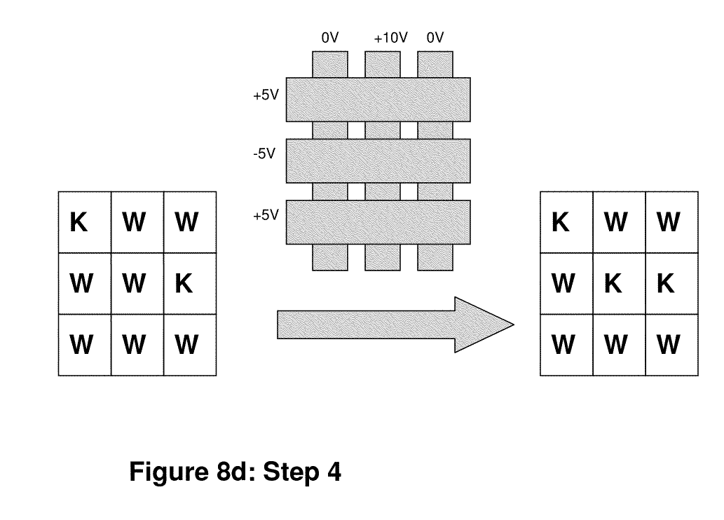

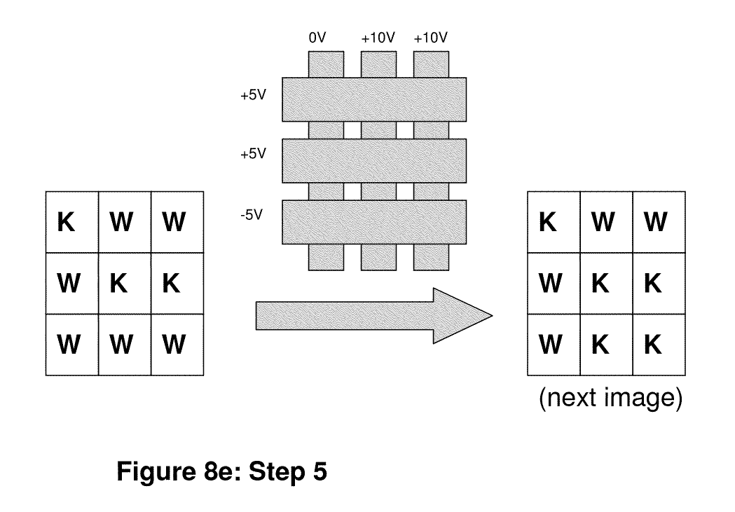

FIGS. 8a-8e illustrate the steps of an alternative driving method. The pixels in this method are driven line by line and in this example, black pixels are driven to white before white pixels are driven to black.

In step 1 (FIG. 8a), only line 1 is driven to switch any black pixels to white if the pixels are to be in the white state in the next image. In this example, pixel (b) at line 1 is the only pixel that needs to be driven from black to white. To accomplish this, column electrodes C1-C3 are applied voltages of 0V, −10V and 0V, respectively and row electrodes R1-R3 are applied voltages of +5V, −5V and −5V, respectively. As a result, pixel (b) senses a voltage of −15V, and therefore switches to the white state (see FIGS. 2a, 3b, 4a and 5b). The colors of the remaining pixels which sense a voltage of +5V or −5V will remain unchanged.

In the next step (FIG. 8b), only line 2 is driven to switch any pixels from black to white if the pixels are to be in the white state in the next image. In this example, pixel (d) is the only pixel that needs to be driven from black to white. To accomplish this, column electrodes C1-C3 are applied voltages of −10V, 0V and 0V, respectively and row electrodes R1-R3 are applied voltages of −5V, +5V and −5V, respectively. Pixel (d) senses a driving voltage of −15V and switches from black to white and the remaining pixels sense a voltage of either +5V or −5V and their colors remain unchanged.

There are no pixels at line 3 that need to be driven from black to white.

In the next step (FIG. 8c), only line 1 is driven to switch any pixels from white to black if the pixels are to be in the black state in the next image. In this example, pixel (a) is the only pixel that needs to be driven to the black state. To accomplish this, column electrodes C1-C3 are applied voltages of +10V, 0V and 0V, respectively and row electrodes R1-R3 are applied voltages of −5V, +5V and +5V, respectively. Pixel (a) senses a driving voltage of +15V and therefore switches from white to black and the remaining pixels sense a voltage of either +5V or −5V and therefore their colors remain unchanged.

In the next step (FIG. 8d), only line 2 is driven to switch any pixels from white to black if the pixels are to be in the black state in the next image. In this example, pixel (e) is the only pixel that needs to be driven to the black state. To accomplish this, column electrodes C1-C3 are applied voltages of 0V, +10V and 0V, respectively and row electrodes R1-R3 are applied voltages of +5V, −5V and +5V, respectively. Pixel (e) senses a driving voltage of +15V and as a result, switches from white to black and the remaining pixels sense a voltage of either +5V or −5V and their colors remain unchanged.

In the next step (FIG. 8e), only line 3 is driven to switch any pixels from white to black if the pixels are to be in the black state in the next image. In this example, pixels (h) and (i) are the only pixels that need to be driven to the black state. To accomplish this, column electrodes C1-C3 are applied voltages of 0V, +10V and +10V, respectively and row electrodes R1-R3 are applied voltages of +5V, +5V and −5V, respectively. Pixels (h) and (i) sense a driving voltage of +15V and as a result, switch from white to black and the remaining pixels sense a voltage of either +5V or −5V and their colors remain unchanged.

The driving, as shown, is carried out line by line until the last line when all pixels have been driven to their color states in the next image.

Accordingly, this alternative driving method may be summarized as:

A driving method for driving a display device of a binary color system of a first color and a second color, from a current image to a next image, which method comprises

(a) driving, line by line, pixels having the first color in the current image and having the second color in the next image, from the first color to the second color; and

(b) driving, line by line, pixels having the second color in the current image and having the first color in the next image, from the second color to the first color.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. An electrophoretic display comprising
a) a plurality of pixels each of which
(i) has a viewing side and a non-viewing side, and
(ii) is sandwiched between a top electrode and a bottom electrode; and
b) an electrophoretic fluid comprising two types of charged pigment particles which
(i) carry opposite charge polarities,
(ii) have contrasting colors of a first color and a second color and,
(iii) have different levels of charge intensity,
wherein when a voltage is applied to a pixel, which is at least one third of the voltage required to drive the pixel from the first color to the second color or from the second color to the first color, the pixel remains unchanged in color on the viewing side, whereas a mixture of the two types of charged pigment particles gather at the non-viewing side to form an intermediate color between the first color and the second color.

2. The display of claim 1, wherein the top electrode and the bottom electrode are row and column electrodes in a passive matrix driving system.

3. The display of claim 1, wherein the two types of charged pigment particles are black and white.

4. The display of claim 3, wherein the white particles are negatively charged and the black particles are positively charged, or vice versa.

5. The display of claim 3, wherein the volume of the black particles is about 6% to about 15% of the volume of the white particles.

6. The display of claim 3, wherein the volume of the black particles is about 20% to about 50% of the volume of the white particles.

7. The display of claim 3, wherein the electrophoretic fluid further comprises a third type of particles.

8. The display of claim 7, wherein the third type of particles is white or black.

9. The display of claim 7, wherein the third type of particles are non-charged or slightly charged.

10. The display of claim 7, wherein the third type of particles is larger than the oppositely charged black and white particles.

11. The display of claim 10, wherein the third type of particles is about 2 to about 50 times the size of the oppositely charged black or white particles.

12. The display of claim 7, wherein the size of the third type of particles is larger than 20 μm.

13. The display of claim 7, wherein the third type of particles is formed from a polymeric material.

14. The display of claim 7, wherein the third type of particles has a different level of mobility than those of the oppositely charged black and white particles.

15. The display of claim 7, wherein the concentration of the third type of particles is less than 25% by volume in the fluid.
